(19) United States
(12) Patent Application Publication
(10) Pub. No.: US 2010/0169063 A1
(43) Pub. Date: Jul. 1, 2010

(54) System and Method of Modeling the Pharmacodynamic Effect to Drugs Delivered to a Patient

(75) Inventors: Laurence M. Yudkovitch, Mequon, WI (US); Ronald P. Makin, Fitchburg, WI (US); Rene Coffeng, Helinski (FI); Michael D. Krajnak, Waukesha, WI (US)

Correspondence Address: Andrus, Sceales, Starke & Sawall, LLP, 100 East Wisconsin Avenue, Suite 1100, Milwaukee, WI, 53202-4178, US

(73) Assignee: The General Electric Company, Schenectady, NY (US)

(21) Appl. No.: 12/347,139

(22) Filed: Dec. 31, 2008

(51) Int. Cl. G06G 7/48

(52) U.S. Cl. 703/11

(57) ABSTRACT

A system and method of modeling the pharmacodynamic effect of drugs delivered to a patient. The system includes a model database comprising a first drug interaction model and a second drug interaction model. A processing unit determines a first pharmacodynamic effect and a second pharmacodynamic effect and using a dominance rule to compare the first pharmacodynamic effect and a second pharmacodynamic effect to determine a dominant interaction model. A graphical display connected to the processing unit presents the determined dominant interaction model. The method includes the steps of obtaining first, second, and third drug concentrations, applying a first model that models a first pharmacodynamic effect, applying a second model that models a second pharmacodynamic effect and comparing the first pharmacodynamic effect to the second pharmacodynamic effect to determine which of the first model and the second model is the dominant pharmacodynamic model, and presenting the determined dominant pharmacodynamic model on a graphic display.

### BACKGROUND

The present disclosure relates to the field of drug modeling. More specifically, the present disclosure relates to the modeling of the pharmacodynamic effect of one or more drugs delivered to a patient.

In the emergency room or operating room, an anesthesiologist needs to assess the patient's condition and adjust the anesthetic therapy using a wide variety of distinct medical devices. These devices often have limited communication abilities between each other resulting in an incomplete depiction of the patient's condition to the anesthesiologist. A clinician must therefore keep track of the patient's level of sedation, analgesia, and neuromuscular blockade, the three physiological components of anesthesia, based upon the recall of the drugs administered and the anesthetic effects that these drugs produce on their own and in combination with each other.

The practice of intra-operative anesthesia typically involves administering sedative, analgesia, and neuromuscular blocking drugs or agents to a patient. These drugs manage the patient's level of consciousness, pain management, and neuromuscular blockade. Typically, each drug has a pharmacokinetic (PK) model that specifies what the body does to the drug and a pharmacodynamic (PD) model that specifies the effect that the drug produces as it interacts with the body. More specifically, the PK model represents how the drug is absorbed, distributed, and eliminated by the patient's body. The PD model approximates the effect of the drug over time within the patient's body. These models are usually derived in isolation from one another based upon standard demographic information of the patient such as sex, age, height, and weight. However, in a clinical setting, multiple drugs are typically used together. The interactions between these drugs may be additive, and produce a total effect the same as the sum of the individual effects; may be synergistic, and produce a greater total effect than the sum of the individual drug effects; or may be antagonistic, and produce less of a total effect than the sum of the individual drug effects.

Displays may present both the PK and PD graphs to the clinician in real time. This display, however, is limited in its ability to present information regarding total patient anesthesia due to the interactive effects of the delivered drugs. Therefore, an improved system and method for the modeling and display of pharmacodynamic effects of drugs is desired.

### BRIEF DISCLOSURE

Systems and methods of modeling the pharmacodynamic effect of drugs delivered to a patient are disclosed in further detail herein. A method of modeling the pharmacodynamic effect of drugs delivered to a patient includes obtaining a first drug concentration, a second drug concentration, and a third drug concentration. A first model is applied to the first drug concentration and the second drug concentration. The first model models a first pharmacodynamic effect attributable to the interaction of the first drug and the second drug. A second model is applied to the second drug concentration and the third drug concentration. The second model models a second pharmacodynamic effect attributable to the interaction of the second drug and the third drug. The first pharmacodynamic effect is compared to the second pharmacodynamic effect to determine which of the first model or the second model is the dominant pharmacodynamic model that is presented on a graphical display.

In an alternative embodiment of a method of displaying a visual representation of the pharmacodynamic effect of anesthetic drugs delivered to a patient, the method includes obtaining a first anesthetic drug concentration, a second anesthetic drug concentration, and third anesthetic drug concentration. The first anesthetic drug concentration and the second anesthetic drug concentration are applied to a first pharmacodynamic model in order to model a first pharmacodynamic effect attributable to the first anesthetic drug concentration and the second anesthetic drug concentration. The third anesthetic drug concentration is applied to a second pharmacodynamic model to model a second pharmacodynamic effect attributable to the third anesthetic drug concentration. Then, it is determined which of the first model and the second model is the dominant pharmacodynamic model by comparing the first pharmacodynamic effect and the second pharmacodynamic effect. The dominant pharmacodynamic model is displayed on a graphical display.

Additionally, a system for modeling the pharmacodynamic effect of anesthetic drugs delivered to a patient is also disclosed herein. The system includes an intravenous (IV) anesthetic drug delivery system attached to the patient for the delivery of a first anesthetic drug. The IV anesthetic drug delivery system includes a monitor that measures a first anesthetic drug amount delivered to the patient. An anesthetic gas delivery system is attached to the patient for the delivery of a second anesthetic drug to the patient. The anesthetic gas delivery system includes a monitor that measures a second anesthetic drug amount delivered to the patient. A model database that includes a first drug interaction model and a second drug interaction model. The first and second drug interaction models model the pharmacodynamic effect experienced by a patient due to one or more anesthetic drug. A processing unit is connected to the IV anesthetic drug delivery system to receive the first anesthetic drug amount. The processing unit is connected to the anesthetic gas delivery system to receive the second anesthetic drug amount. The processing unit is further connected to the model database to receive the first drug interaction model and the second drug interaction model. The processing unit further receives an additional anesthetic drug amount that is representative of an amount of an additional anesthetic drug delivered to the patient. The processing unit is configured with computer readable code in order to apply the received first anesthetic drug and anesthetic gas amounts to the first drug interaction model to determine a first pharmacodynamic effect on the patient and to apply the received additional anesthetic drug amount to the second drug interaction model to determine a second pharmacodynamic effect on the patient. A rules database comprises a dominance rule and the processing unit receives the dominance rule from the rules database and uses the dominance rule to compare the first pharmacodynamic effect and the second pharmacodynamic effect to determine a dominant interaction model. A graphical display is connected to the processing unit and the graphical display receives the determined dominant interaction model and presents the pharmacodynamic effect of the dominant interaction model.

### BRIEF DESCRIPTION OF THE DRAWINGS

In the drawings:

FIG. 1 is system diagram depicting an embodiment of a system for modeling a pharmacodynamic effect;

FIG. 2 is a system diagram depicting a more detailed embodiment of a system for modeling a pharmacodynamic effect;

FIG. 3 is a flow chart depicting the steps of an embodiment of a method of modeling the pharmacodynamic effect of drugs delivered to a patient; and

FIG. 4 depicts an embodiment of a graphical display for displaying the pharmacodynamic effect of drugs.

### DETAILED DISCLOSURE

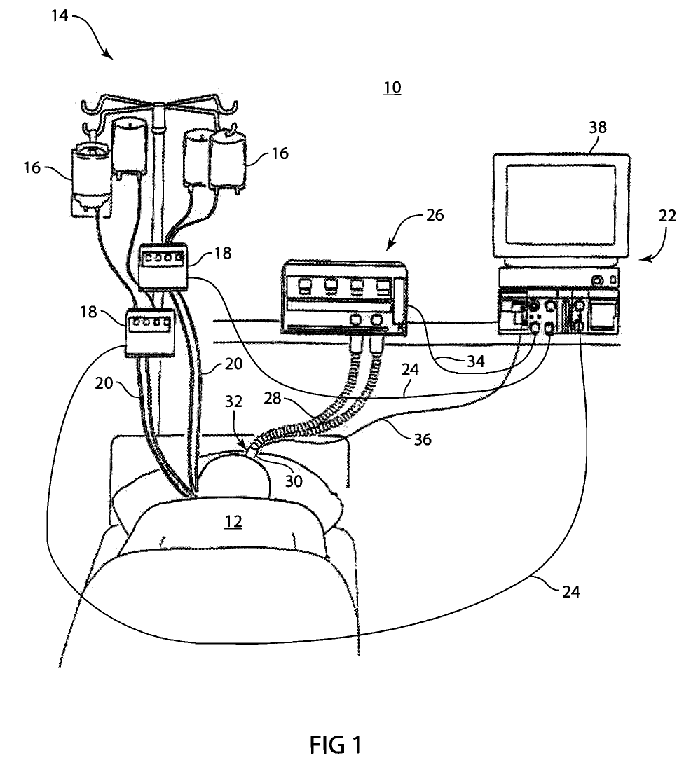

FIG. 1 depicts an embodiment of a system 10 for modeling the pharmacodynamic effect of drugs delivered to a patient 12. The embodiment of the system 10 includes an intravenous (IV) drug delivery system 14 that includes one or more bags of a liquid IV drug 16 that are connected to an IV pump 18. The IV pump 18 controls the flow of the IV drug 16 to which it is connected into the patient via a catheter 20. The IV pump 18 not only controls the flow of the IV drug 16, but also monitors the flow of the IV drug 16 such that an IV drug amount may be transmitted to a drug interaction computer 22 via line 24. Alternatively, the IV drug delivery system 14 may be a manual or automated syringe IV drug delivery system, such as is commonly found in operating room settings. The drug interaction computer 22 may be a specific use computer programmed to model drug interactions, or may be a general use computer programmed with computer readable code such as to enable the general use computer to specifically perform the functions of modeling drug interactions.

The system 10 further includes a medical gas delivery system 26. The medical gas delivery system 26 includes those elements typically known for the delivery of medical gas, including one or more sources of medical gas. The one or more sources of medical gas may include inhaled anesthetic gases; balance gases, such as nitrogen; or oxygen. The medical gas delivery system 26 may further provide ventilatory support to the patient 12 as a patient that receives anesthesia may require mechanical ventilation or ventilation assistance due to the patient's weakened or anesthetized state. The medical gas is delivered to the patient 12 via a tube 28 and a Y connection 30 that connects the patient to an inspiratory limb and an expiratory limb.

In or around the Y connection 30, and typically in or near the expiratory limb, a gas sensor 32 may be placed in order to analyze the gases exhaled by the patient 12. The concentrations of the component gases in the exhaled gas can be an important measurement as this can be used to derive the amount of inhaled anesthetic drug delivered to the patient 12. The medical gas delivery system 26 is connected to the drug interaction computer 22 via line 34, the gas sensor 32 is connected to the gas monitor (not depicted) which may be a module of the drug interaction computer 22 via line 36. If the gas monitor is independent from the drug interaction computer 22, the subsequent data from the monitor is then transferred to the drug interaction computer 22. Line 36 allows exhaled medical gas concentrations to be delivered to the drug interaction computer 22 for further processing.

It should be understood that lines 24, 34, and 36 as depicted in this embodiment may be any type of data transmission line that is suitable for the delivery of data in a clinical setting. Alternatively, lines 24, 34, and 36 may be replaced by wireless data transmission technologies such as, but not limited to, Bluetooth, RF, and infrared.

It should be further understood that while the intravenous drug delivery system 14 and the medical gas delivery system 26 are herein described in further detail for the administration of anesthetic drug to the patient, a wide variety of other anesthesia delivery systems or techniques may be also used. These other anesthesia delivery techniques may include an injection or a bolus of an anesthetic drug or an orally administered anesthetic drug. In these embodiments, the administering clinician may manually enter the administered drug amount into the drug interaction computer 22. However, these additional anesthetic drug delivery techniques are to be included in and not limiting to the means by which the anesthetic drugs are administered to the patient.

When the patient 12 receives anesthetic treatment, the anesthesia typically involves three components of anesthetic drugs. These anesthetic drugs include an analgesic, a sedative, and a neuromuscular block. Depending on the specific drugs used for the anesthesia, the patient may receive one or more drugs from each of the IV drug delivery system 14 and the medical gas delivery system 26. Additionally, the patient may receive the component anesthetic drugs in a particular order, creating different combinations at different times such as to properly take the patient through the three phases of anesthesia, namely, induction, maintenance, and emergence. Additionally, the anesthesiologist may deliver to the patient 12 one or more drugs from each of the anesthesia components based upon the characteristics of the procedure, patient, or desired anesthesia.

Analgesics commonly used in anesthesia may include opioids such as the fentanyl family. This family of drugs includes remifentanil, fentanyl, sufentanil, and alfentanil. Members of this family of drugs are typically delivered intravenously as either a bolus or an infusion. One or more of these analgesics may be combined with a sedative to provide an anesthetic effect. The sedative may include the intravenously delivered propofol or thiopental, but may also include inhaled sedative gases such as sevoflurane, isoflurane, desflurane, enflurane, halothane, or nitrous oxide (N₂O). It should be also understood that neuromuscular blocking agent, for example, rocuronium, vecuronium, pancuronium, and mivacurium, may also be delivered to the patient as part of the prescribed anesthesia. However, the presently disclosed example will focus on the interaction between analgesic and sedative drugs for more detailed disclosure.

While anesthetic drug may be referred to as one of an analgesic, sedative, or neuromuscular blocking agent, it is to be understood that each of these drugs may also produce pharmacodynamic (PD) effects in more than one or all three of the components of anesthesia. However, for the ease of classification and description, a primary effect of each of the drugs is used to classify the drugs within the terms of the description. As will be detailed further herein, the additional anesthetic effects of these drugs may cause different PD effects in the patient's sedation, analgesia, or neuromuscular blockade depending on whether these drugs are acting in isolation or in combination with other drugs.

While FIG. 1 is representative of the system configured for use in an intensive or critical care setting, in an operating room setting the IV pumps 18 could be replaced by syringe pumps and the medical gas delivery system 26 may be replaced by an anesthesia machine that provides the necessary ventilatory and monitoring support.

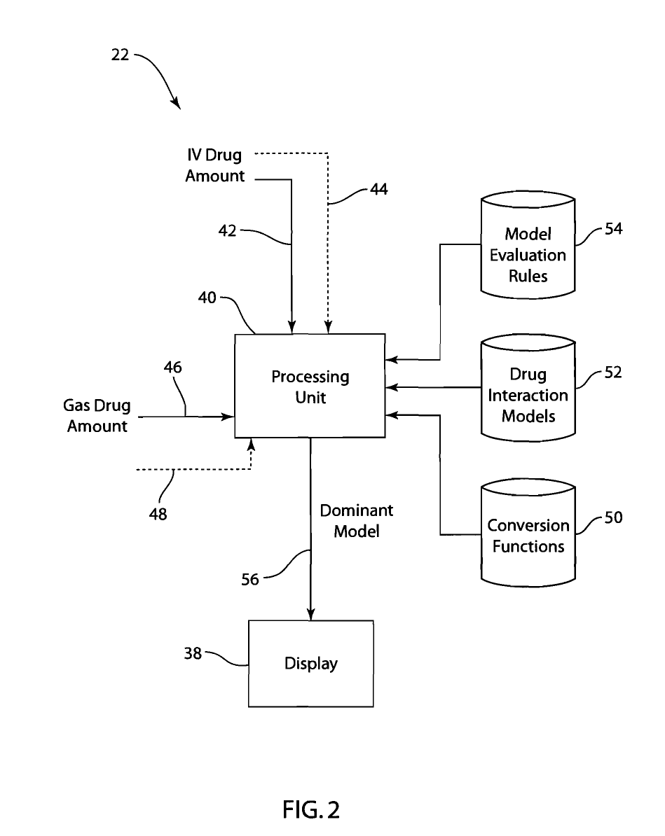

FIG. 2 is a more detailed system diagram of the drug interaction computer 22. The drug interaction computer 22 includes a processing unit 40. The processing unit 40 may be a microprocessor or other type of controller that is programmed with computer readable code such as to make the processing unit 40 capable of specifically performing the functions of a drug interaction computer 22. The processing unit 40 receives an IV drug amount 42 from an IV pump 18 via line 24 as depicted in FIG. 1. Additionally, the processing unit 40 may receive an additional IV drug amount 44 if the patient is receiving anesthesia using more than one intravenous anesthetic drug. The processing unit 40 further receives a gas drug amount 46. This anesthetic gas amount may be received from the medical gas delivery system 26 via the line 34. Additionally, the processing unit 40 may receive a gas drug amount or gas concentration from the gas sensor 32 via line 36 in FIG. 1 such that the amount of anesthetic gas delivered and retained by the patient 12 may be determined. Additionally, if more than one anesthetic gas is being simultaneously delivered to the patient, then the processing unit 40 may also receive an additional gas drug amount 48.

The processing unit 40 takes the received IV drug amount 42 and gas drug amount 46 and may use a method as will be described in further detail below, to process the received IV drug amount 42 and received gas drug amount 46. The processing unit 40 is further connected to databases that provide additional information to the processing unit 40. While these databases are depicted as being individual entities within the drug interaction computer 22, it is understood that these databases may be part of the same database or may be external to the drug interaction computer 22, but connected to the drug interaction computer 22 in a communicative fashion, such as via a communications network, for example, a LAN network or the Internet.

The processing unit 40 is connected to a database of conversion functions 50. These conversion functions, stored in the database 50, will be described in greater detail below, but are functions that are used to convert the received anesthetic drug amounts from the amount of the actual anesthetic drug delivered to the patient into a virtual amount or concentration of an anesthetic drug for which there is a drug interaction model, if there is no drug interaction model for that specific anesthetic drug that is actually delivered to the patient.

The processing unit 40 is also connected to a database of drug interaction models 52. The drug interaction models stored in database 52 are pharmacodynamic models that estimate and predict the pharmacodynamic (PD) effect felt by the patient due to one anesthetic drug or a combination of two or more anesthetic drugs. The PD models directed to modeling the PD effect of a combination of anesthetic drugs may be referred to as drug interaction models and may reflect different potential combinations of anesthetic drugs. For example, a drug interaction model may be specific to a combination of a specific sedative drug and a specific analgesic drug.

The processing unit 40 is further connected to a model evaluation rules database 54. The model evaluation rules found in the database 54 may include Boolean or fuzzy logic rules that may be applied by the processing unit 40 to the drug interaction models to compare, select, and evaluate the drug interaction models in the drug interaction model database 52. The model rules database 54 may include selection rules for selecting the appropriate drug interaction models based on the received anesthetic drug amounts; dominance rules for selecting a dominant model for the current PD effect; and validity rules for checking to ensure that the applied drug interaction models are producing valid results. The model evaluation rules are used by processing unit 40 to determine which of one or more drug interaction models currently being used by the processing unit 40 is a dominant model that should be used to model the pharmacodynamic effect experienced by the patient. This identified dominant model 56 is then displayed on a graphical display 38 as depicted in FIGS. 1 and 2.

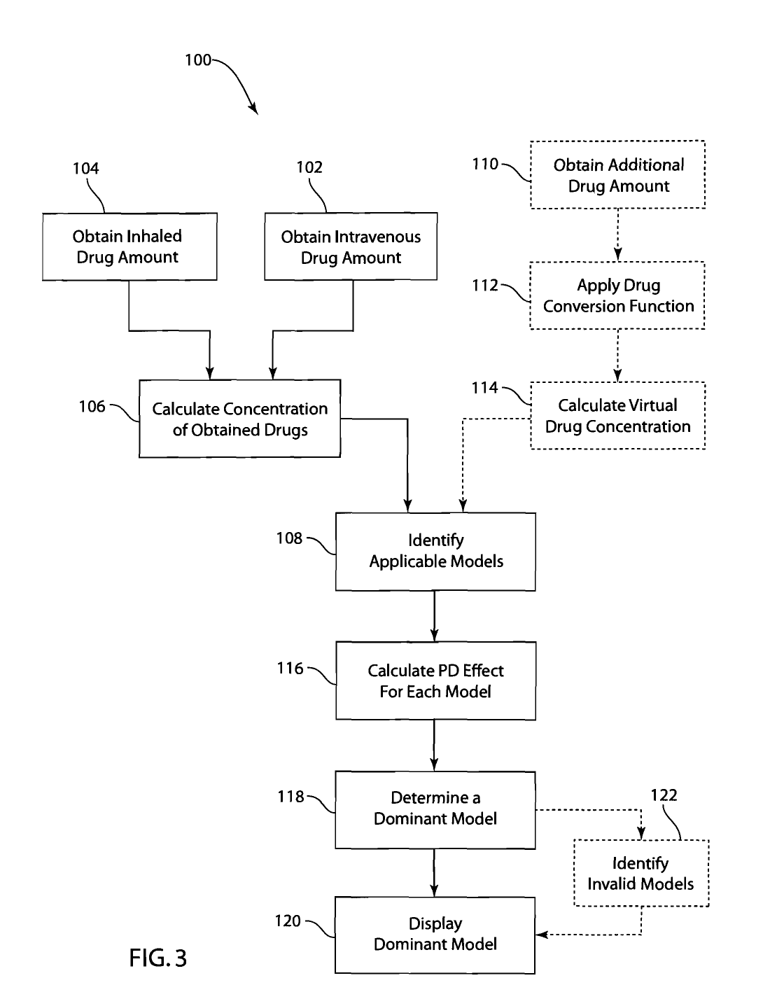

FIG. 3 depicts a flow chart of a method 100 of modeling the pharmacodynamic effects of one or more drugs delivered to a patient. In the method, first an amount of an intravenous drug delivered to the patient is obtained at step 102. This drug amount may be obtained from an IV pump, or may be otherwise entered by a clinician, such as in the event of the administration of an injection or bolus of a drug to the patient. Step 102 may further include obtaining additional intravenous drug amounts, including as many drugs as are intravenously delivered to the patient.

The method also includes the step 104 of obtaining an inhaled drug amount. This may be obtained from a medical gas delivery system. Step 104 may further include obtaining inhaled drug amounts for additional inhaled drugs for as many inhaled drugs as are delivered to the patient. Additionally, step 104 may further include obtaining an exhaled drug amount or concentration, such as from a gas sensor connected to the patient, such as to derive the amount of the anesthetic drug is delivered to the patient and retained in the patient's body using the anesthetic drug that is exhaled by the patient.

While the method 100 has been described including steps 102 of obtaining an intravenous drug amount and step 104 of obtaining an inhaled drug amount, it should be understood that alternative embodiments of the method may include obtaining anesthetic drug amount from any applicable anesthetic drug administration technique. Thus, in some embodiments, the anesthetic drugs may be delivered solely through inhalation, while in other embodiments the anesthetic drugs are delivered solely through intravenous means. This description is not intended to be limiting on the method in terms of the specific anesthetic drug delivery techniques employed.

Next, the obtained intravenous drug amount 102 and obtained inhaled drug amount 104 are used to calculate the concentration of the obtained drugs in step 106. Alternatively, instead of calculating the concentration of the obtained drugs in step 106, the drug concentrations may be themselves obtained from a monitoring system with the functionality to determine patient blood concentration of anesthetic drugs.

Then at step 108, applicable pharmacodynamic (PD) interaction models are identified based upon the intravenous inhaled drugs delivered to the patient. This identification in step 108 may be performed using logical model selection rules from the model evaluation rules database 54 in FIG. 2. The interaction models may be stored in the drug interaction models database 52 in FIG. 2. The interaction models may relate the resulting pharmacodynamic effect experienced by the patient based upon a single anesthetic drug, or a combination of two or more anesthetic drugs. Interaction models may exist for each of a variety of potential drug combinations that may be delivered to the patient such that these models may accurately reflect the interactions of the one or more anesthetic drugs currently administered, or still present in the patient.

In an alterative embodiment, the drug interaction models may only include models of the most common drug interactions. In this embodiment, the method uses steps 110-114 in order to create a virtual drug concentration that matches required drugs of one of the drug interaction models by converting the administered drug into a virtual concentration of a drug for which there is an interaction model. In this embodiment, in step 110 the additional drug amount is obtained. Next, in step 112 a drug conversion function is applied to the obtained additional drug amount. This allows the calculation of the virtual drug concentration in step 114. The virtual drug concentration from step 114 is then used to identify the interaction models in step 108 to which the virtual drug concentration can be applied.

In one example of this embodiment, the drug interaction models may include a model for the remifentanil-propofol interaction and a drug interaction model for the remifentanil-sevoflurane interaction. The patient is then administered a combination of the sedative desflurane and the analgesic sufentanil. The amounts of the delivered desflurane and sufentanil are then obtained at step 110 as a drug interaction model for these drugs may not be available. At step 112, a drug conversion function is applied to the obtained desflurane amount and sufentanil amount in order to convert the delivered desflurane and sufentanil into virtual drug concentrations of sevoflurane and remifentanil, respectively.

Conversions within in the flurane family of inhaled sedatives may be made using minimum alveolar concentration (MAC) equivalency based functions. The MAC equivalency is a measurement of the potency of an inhaled agent based upon the concentration of the agent required in the patient's lungs in order to produce a minimum clinical effect. The stronger the sedative agent, a lower alveolar concentration of that agent is required to produce the clinical effect. Therefore, the drugs within the flurane family may be converted to a virtual concentration of a drug within that family (sevoflurane) so that this virtual concentration may be applied to a drug interaction model.

Similarly, the fentanyl family of analgesics are related by the MAC reduction that each drug produces. These opioids produce the effect of reducing the MAC of the inhaled agents required for the minimum clinical effect. This physiological property is known as the MAC reduction and can be used to compare the relative potencies/physiological effects of drugs within the fentanyl family. Therefore, drug conversion functions based upon the MAC reduction property of the fentanyl family may be used to convert an amount of any of these drugs into a virtual drug concentration of a fentanyl family drug (remifentanil) for which there is a drug interaction model.

Therefore, in this embodiment, fewer drug interaction models are required, and yet a robust system that is able to model the interactions between a variety of anesthetic drugs can be produced. It should also be understood that while the flurane family of inhaled sedatives and the fentanyl family of analgesics have been herein described, similar drug conversions may be made for other families of anesthetic agents.

Once the applicable drug interaction models have been identified in step 108, then each of the identified applicable models are used in step 116 to calculate the PD effect based on each of the identified models. Each of the identified models may only include the PD effect attributable to one or some of the anesthetic drugs that are currently delivered to the patient. As each of the drug interaction models focus on specific interactions between one or more drugs, each of the PD effects calculated by the different models may be slightly different, and therefore in step 118 a dominant drug interaction model must be determined. In the step of determining a dominant model, dominance rules from a model evaluation rules database 54 may be used that help to identify which of the models is the dominant model for the PD effect experienced by the patient. The dominance rules from the model evaluation rules database may include Boolean or fuzzy logic rules that help to determine the dominant model of the patient's PD effects.

In one embodiment, the dominance rule identifies the model that is attributable to the greatest portion of the PD effect as the dominant model. In alternative embodiments, a model must be attributable for 90% or more of the total PD effect experienced by the patient to be identified as the dominant model. In yet other embodiments, the dominance rule may include a comparison to another clinical observations or measured physiological parameters. However, it should be understood by one skilled in the art that many additional dominance rules may be used to evaluate two or more applicable drug interaction models, these rules are considered to be within the scope of this disclosure.

Once the dominant model is determined in step 118 then the dominant model is displayed in step 120 on a graphical display, such as graphical display 38 as depicted in FIGS. 1 and 2.

In an additional step of the method 100, the calculated PD effects for each model from step 116 may be analyzed to identify any invalid models in step 122. The interaction of specific drug combinations may result in invalidating particular drug interaction models and therefore a step to identify any invalid drug interaction models may be required.

Validity rules may be used to identify when a drug interaction model is valid or has become invalid. The validity rules may identify invalidating situations for the identified drug interaction models, such as particular combination of drugs, the presence of the combination of the actual drugs versus the calculated virtual concentrations, or additional medications that the patient may be receiving. Further examples of validity rules may include identifying if the applicable drug interaction models only account for a plurality majority of the total PD effect; two or more of the drug interaction models being each attributable for at least 10% of the total PD effect; or the determined dominant model is either less than two times or three times greater than the PD effect of the other drug interaction models. However, it is intended that the preceding list of validity rules be non-limiting, and the full scope of applicable validity rules as would be recognized by one skilled in the art be within the scope of the present disclosure.

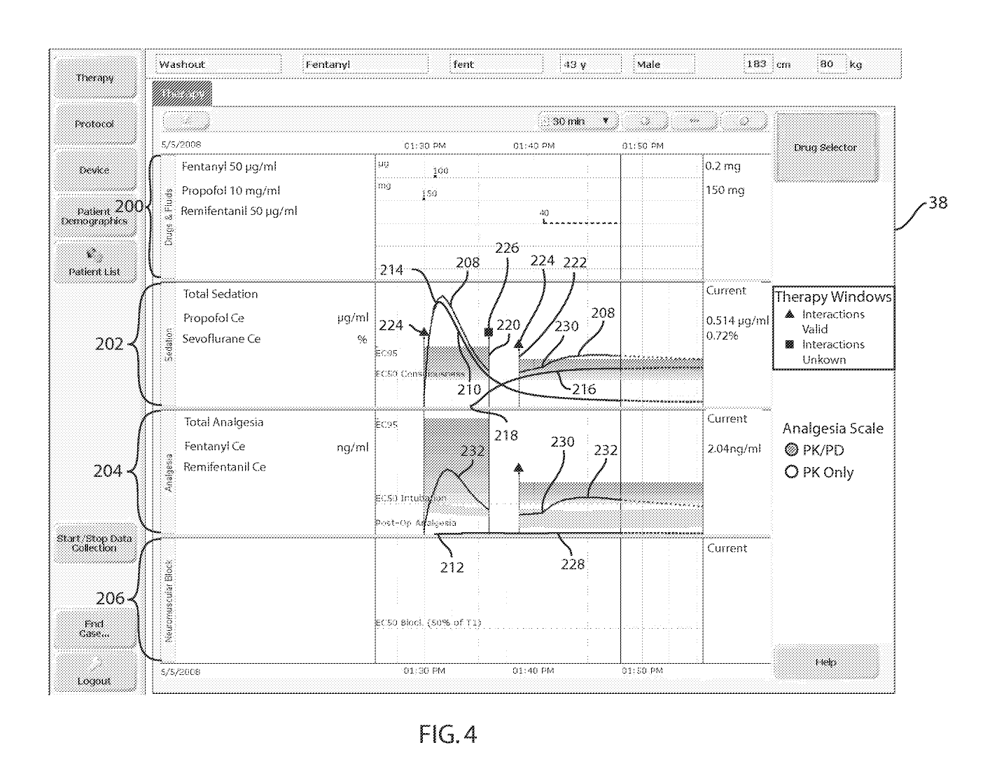

Additional embodiments of the system and method as disclosed herein may use dominance rules or validity rules that are based upon the anesthetic delivery concept effect site concentration (Ce). The effective concentration is typically denoted as EC, The effect site concentration that produces 50% of maximal effect is denoted EC₅₀. Similarly, EC₉₅ is the effect site concentration that produces 95% of maximal effect. Alternative embodiments may calculate these effect site concentration amounts, such as are displayed in FIG. 4, to be described in greater detail herein. In these embodiments, dominance rules that compare the interaction models based upon PD or PK calculations may further incorporate this concept of effect site concentration. Similarly, model validity rules may be used in some embodiments, wherein one or more drug interaction models are deemed to be invalid if the effect site concentration falls below the EC₅₀ or the EC₉₅ level.

FIG. 4 depicts an embodiment of the presentation of information on a graphical display 38. In this embodiment, the graphical display is divided into four information regions, namely a drugs and fluids region 200, a sedation region 202, an analgesia region 204, and a neuromuscular block region 206.

In the drugs and fluids region 200, a listing of the drugs and fluids administered to the patient is provided along with a visual indication of the time that the drugs were administered, the type of administration (i.e. whether the drugs were administered in a bolus or an infusion), and the amount of the drug delivered.

Next, referring to the sedation region 202, pharmacokinetic (PK) and pharmacodynamic (PD) graphs related to the sedation of the patient are displayed. The total sedation 208 is the pharmacodynamic effect experienced by the patient due to the combination of the sedative and analgesic drugs. The pharmacokinetic property of the drugs is also displayed. The pharmacokinetic graphs show the uptake distribution and elimination of the drugs based on their specific model. In the sedation region 202, two different sedative drugs are displayed, namely that of propofol, and that of sevoflurane.

The propofol pharmacokinetic graph 210 shows that when the propofol is initially administered, the patient's total sedation tracks the propofol concentration, as it is the only drug currently administered to the patient. However, this changes when an analgesia drug, fentanyl, is administered to the patient, as reflected by the fentanyl PK graph 212 in the analgesia region 204. At the time of the administration of the fentanyl, the total sedation 208 deviates from the propofol PK graph 210 as the interaction between the fentanyl and the propofol produces a greater total sedation than that which is solely attributable to the propofol. Thus, at reference point 214, the introduction of the fentanyl and the resulting change in the total sedation PD graph indicates a change in the drug interaction model used to calculate the total sedation experienced by the patient. Prior to reference point 214 a drug interaction model based solely on the effects of propofol may be used; however, after the administration of the fentanyl, a new drug interaction model that accurately reflects the PD effects of a combination of propofol and fentanyl may be employed in order to produce a better representation of the total PD effects of the administered drugs.

Next, it can be seen in the sedation region 202, the patient is then administered sevoflurane as represented by the sevoflurane PK graph 216. While initially, starting at reference point 218, and until reference point 220, the sevoflurane is administered, but the propofol/fentanyl drug interaction model is deemed to be the dominant model of the PD effects experienced by the patient and therefore is used for the total sedation graph 208. Next, between reference points 220 and 222 one or more of the applicable drug interaction models, namely that of the propofol/fentanyl interaction model, or the sevoflurane/fentanyl interaction model is deemed to be invalid, and therefore in this embodiment no total sedation graph 208 is depicted. Validity symbols representing valid 224 and invalid 226 drug interaction models may be used at these reference points in order to identify to a clinician the times at which the drug interaction models are valid or invalid. The validity determination, as described previously, may be based upon a set of rules that are defined to evaluate the validity and/or invalidity of particular drug interaction models based upon the changing conditions experienced by the patient. Then at reference point 222 and as noted by validity symbol 224, once the sevoflurane drug interaction model becomes the dominant, and valid, model the total sedation graph 208 resumes and continues depicting the total pharmacodynamic effect experienced by the patient due to the sevoflurane/fentanyl interaction.

Next, remifentanil is introduced to the patient as depicted in the analgesia region 204 by the onset of the remifentanil PK graph 228. This coincides with reference point 230 in the total sedation graph 208 where the total sedation increases to reflect the introduction of this new analgesic drug. Thus, the drug interaction model for the total sedation 208 may change again at reference point 230 in order to switch to a sevoflurane/remifentanil drug interaction model. In an alternative embodiment wherein the remifentanil drug interaction model was not available, the administered remifentanil may be converted into a virtual concentration of fentanyl and the previously used sevoflurance/fentanyl drug interaction model may be continued to be used in order to present the calculated total sedation 208.

It should be further noted that in the analgesia region 204, a total analgesia graph 232, similar to the total sedation graph 208 in sedation region 202, is depicted and drug interaction models calculating the total analgesia are similarly employed in the analgesia region 204 in order to accurately present the total analgesia experienced by the patient due to the combination of one or more drugs with analgesic effect. It is to be understood that the similar analysis as described above with respect to the sedation region 202 and the total sedation graph 208 is applicable to the analgesia region 204 and the total analgesia graph 232. While the example depicted in FIG. 4 does not include the administration or analysis of any neuromuscular blocking agents, this is also an important component of patient anesthesia and therefore is to be expected that in embodiments, neuromuscular blocking agents may be administered and displayed in the drugs and fluids region 200 and a graph indicating total neuromuscular blockade and PK graphs representing the concentration of neuromuscular blocking agents may be included in the neuromuscular block region 206. The analysis and display of this information in the neuromuscular block region would also be expected to be similar to that previously described above with respect to the total sedation region 202. In some embodiments, the drug interaction models may be limited to a single anesthesia component such as sedation, analgesia, or neuromuscular blockade; however, in other embodiments, the drug interaction models may be applicable to derive PD effect graphs for some or all of the components of anesthesia.

It should be noted that in some embodiments of the system and method as disclosed herein the system and/or method may be performed solely through the use of a computer. In such embodiments, the elements of the system and/or method may be comprised of or carried out by, one or more program, computer program component or computer program module carried out by a microprocessor of the computer in order to perform the described function or represent the described system element. The technical effect of such embodiments solely implemented through the use of a computer is to provide a clinician with improved modeling of the pharmacodynamic effects experienced by the patient attributable to the interactions of a plurality of anesthetic drugs.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method of a drug interaction computer modeling the pharmacodynamic effect of drugs delivered to a patient, the method comprising the drug interaction computer performing the steps of:
obtaining a first drug concentration;
obtaining a second drug concentration;
obtaining a third drug concentration;
applying a first model from a model database to the first drug concentration and the second drug concentration that models a first pharmacodynamic effect attributable to the interaction of the first drug and the second drug;
applying a second model from the model database to the second drug concentration and the third drug concentration that models a second pharmacodynamic effect attributable to the interaction of the second drug and the third drug;
comparing the first pharmacodynamic effect to the second pharmacodynamic effect to determine which of the first model and the second model is the dominant model; and
presenting the dominant pharmacodynamic model on a graphical display.

2. The method of claim 1 further comprising the drug interaction computer:
obtaining a first drug amount;
calculating the first drug concentration;
obtaining a second drug amount;
calculating the second drug concentration;
obtaining a third drug amount; and
calculating the third drug concentration.

3. The method of claim 2 wherein the comparison between the first pharmacodynamic effect and the second pharmacodynamic effect further comprises the drug interaction computer:
calculating the pharmacodynamic effect of the interaction between the first drug and the second drug using the first model;
calculating the pharmacodynamic effect of the interaction between the second drug and the third drug using the second model;
combining the calculated first and second pharmacodynamic effects to determine a total pharmacodynamic effect; and
determining a dominant model out of the first model and the second model, wherein the dominant model is the model to which the greater percentage of the total pharmacodynamic effect is attributable.

4. The method of claim 3 wherein the first model or the second model is dominant if 90% or more of the total pharmacodynamic effect is attributable to that model.

5. The method of claim 3, further comprising:
determining if the first model or the second model is invalid; and
if the first model or the second model is invalid, presenting an indication that the first model or the second model is invalid on the graphical display, and if the first and second models are valid, presenting an indication on the graphical display that the models are valid.

6. The method of claim 5 wherein displaying the pharmacodynamic effect further comprises providing a visual indication on the graphical display when the first model or the second model is invalid.

7. The method of claim 6 further comprising:
obtaining updated concentrations for the first, second, and third anesthetic drugs;
calculating an updated first pharmacodynamic effect and an updated second pharmacodynamic effect;
comparing the updated first pharmacodynamic effect and the updated second pharmacodynamic effect to determine an updated dominant model; and
displaying the updated pharmacodynamic effect attributable to the updated dominant model on the graphical display.

8. The method of claim 6 wherein the visual indication indicates which of the first model or second model is invalid.

9. The method of claim 2 wherein the comparison between the first pharmacodynamic effect and the second pharmacodynamic effect uses a first clinician evaluation of the total pharmacodynamic effect.

10. The method of claim 1 wherein the step of obtaining the concentration of the first drug comprises obtaining a virtual concentration of the first drug by obtaining a

11. A system for modeling the pharmacodynamic effect of anesthetic drugs delivered to a patient, the system comprising:
an IV anesthetic drug delivery system attached to the patient for the delivery of a first anesthetic drug, the IV anesthetic drug delivery system including a monitor that measures a first anesthetic drug amount delivered to the patient;
an anesthetic gas delivery system attached to the patient for the delivery of a second anesthetic drug to the patient, the anesthetic gas delivery system including a monitor that measures a second anesthetic drug amount delivered to the patient;
a model database comprising a first drug interaction model and a second drug interaction model that models the pharmacodynamic effect experienced by the patient due to one or more anesthetic drugs;
a drug interaction computer connected to the IV anesthetic drug delivery system to receive the first anesthetic drug amount, connected to the anesthetic gas delivery system to receive the second anesthetic drug amount, and connected to the model database to receive the first drug interaction model and the second drug interaction model, the drug interaction computer further receiving an additional anesthetic drug amount that is representative of an amount of an additional anesthetic drug delivered to the patient, the drug interaction computer being configured with computer readable code in order to apply the received first anesthetic drug and anesthetic gas amounts to the first drug interaction model to determine a first pharmacodynamic effect on the patient and to apply the received additional anesthetic drug amount to the second drug interaction model to determine a second pharmacodynamic effect on the patient;
a rules database connected to the drug interaction computer and comprising a dominance rule, the drug interaction computer receiving the dominance rule from the rules database and using the dominance rule to compare the first pharmacodynamic effect and the second pharmacodynamic effect to determine a dominant interaction model; and
a graphical display connected to the drug interaction computer that receives the determined dominant interaction model and presents the pharmacodynamic effect of the dominant interaction model.

12. The system of claim 11 wherein the rules database further comprises a validity rule, the drug interaction computer receiving the validity rule from the rules database and using the validity rule to make a determination of the validity of the first drug interaction model and the second drug interaction model.

13. The system of claim 12 wherein the rules database further comprises a selection rule, the drug interaction computer receiving the selection rule from the rules database and using the selection rule to select the first drug interaction model and the second drug interaction model from the model database based upon the anesthetic drugs delivered to the patient.

14. The system of claim 13 further comprising a conversion function database connected to the drug interaction computer and comprising a conversion function, the drug interaction computer receiving the conversion function and applying the conversion function to the first anesthetic drug amount or the second anesthetic drug amount to convert the first or second anesthetic drug amount to a virtual concentration of an anesthetic drug for which there is a drug interaction model in the model database.

15. The system of claim 11 wherein the processing unit is further configured with computer readable code in order to apply at least one of the first anesthetic drug amounts or the anesthetic gas amount to the second drug interaction model.

16. A method of displaying a visual representation of the pharmacodynamic effect of anesthetic drugs delivered to a patient on a graphical display, the method comprising:
obtaining from a patient a first anesthetic drug concentration, a second anesthetic drug concentration, and a third anesthetic drug concentration;
applying the first anesthetic drug concentration and the second anesthetic drug concentration to a first pharmacodynamic model with a drug interaction computer to model a first pharmacodynamic effect attributable to the first anesthetic drug concentration and the second anesthetic drug concentration;
applying the third anesthetic drug concentration to a second pharmacodynamic model with the drug interaction computer to model a second pharmacodynamic effect attributable to the third anesthetic drug concentration;
determining, with the drug interaction computer, which of the first model and the second model is the dominant pharmacodynamic model by comparing the first pharmacodynamic effect and the second pharmacodynamic effect; and
displaying the dominant pharmacodynamic model on the graphical display.

17. The method of claim 16 wherein the third anesthetic drug concentration and the second anesthetic drug concentration are applied to the second pharmacodynamic model by the drug interaction computer and the second pharmacodynamic effect is attributable to the second anesthetic drug concentration and the third anesthetic drug concentration.

18. The method of claim 16, further comprising:
obtaining from a patient a fourth anesthetic drug concentration;
applying the third anesthetic drug concentration and the fourth anesthetic drug concentration to the second pharmacodynamic model with the drug interaction computer to model the second pharmacodynamic effect attributable to the third anesthetic drug concentration and the fourth anesthetic drug concentration.

19. The method of claim 16, further comprising the drug interaction computer:
determining if the first model or the second model is invalid; and
presenting an indication that the first model or the second model is invalid on the graphical display.

20. The method of claim 19, wherein the first model or the second model is invalid due to the determined presence of a concentration of a predetermined drug.
